(19) United States
(12) Patent Application Publication
(10) Pub. No.: US 2023/0120842 A1
(43) Pub. Date: Apr. 20, 2023

(54) BEAM STEERING USING PASSIVE RADAR

(71) Applicant: IPCOM GMBH & CO. KG, Pullach (DE)

(72) Inventors: Maik BIENAS, Schoeppenstedt (DE); Andreas SCHMIDT, Braunschweig (DE)

(73) Assignee: IPCom GmbH &Co. KG, Pullach (DE)

(21) Appl. No.: 17/904,484

(22) PCT Filed: Feb. 17, 2021
(86) PCT No.: PCT/EP2021/053815

§ 371 Date: Aug. 18, 2022

(30) Foreign Application Priority Data
Feb. 21, 2020 (EP) 20158728.4

(51) Int. Cl. H04B 7/06; G01S 13/00; G01S 13/86; G01S 13/88

(52) U.S. Cl. CPC H04B 7/0617; G01S 13/003; G01S 13/86; G01S 13/88

(57) ABSTRACT

The invention provides a method of operating a radio communications system first communication device, the method comprising identifying a position of an object which may comprise at least one second communication device by processing electromagnetic radiation emanating passively from the object; steering at least one of a receive beam and a transmit beam towards the object; and determining whether the object comprises at least one second communication device attempting to establish a radio communication with the first communication device.

The present invention relates to a technique for steering radio communication beams to a potential communication device.

Beam forming with adaptive antenna arrays is a technique used to increase the transmit and reception range of radio transceivers. The range extension comes along with a reduction of the beam width (and vice versa). When applying dynamic beam forming for cellular systems, this is typically done by steering such beams towards single user equipment (UE) devices or groups of UEs, wherein the beam direction is continuously adapted to the UE’s position. As this method requires constant feedback from the UE in an uplink direction, it can be used only after a connection was established and not for initial access or cell search.

To enhance the range of a cell for cell search, i.e. for UEs in idle mode, it is possible to steer the beam subsequently into alternative directions to broaden the coverage area. In this case, the downlink signal cannot be received in the whole coverage area at the same time. As the UE requires that the downlink reference signals are receivable for a certain amount of time in order to perform reliable measurements in course of the cell detection procedure, there is a technical limit for this kind of range extension.

A passive radar system is a known technology, that enables detection and tracking of surrounding objects. In contrast to a conventional radar system, no own transmitter is required in the detecting device. Instead, already available signals, such as commercial broadcast and communications signals are used (e.g. signals of a terrestrial TV or radio distribution network or signals stemming from satellites, such as GNSS positioning signals). Consequently, only a radio receiver and a powerful processor are required to process reflections of this radio signals from objects. In the scope of the present invention these objects may be (a group of) people, cars, busses, vessels, airplanes, and so on.

The current beam forming techniques as applied in mobile communication systems are not able to steer a beam towards a UE, that is not providing feedback information for the beam steering. Therefore, the range extension in certain conditions, e.g. for cell search and random access, is limited. Without any feedback from the UE, the position of the target device is not known by the base station (eNB) and therefore the beam could not be steered towards the UE. Instead, it is scanned into alternating directions, which is prolonging the average time until the signal can be picked up and reducing the dwell time in any particular area. This increases the likelihood, that a cell is not detected by the UE or that a random access attempt is unsuccessful.

Peng Jiang et al. in “Self-organizing relay stations in relay based cellular networks”, Computer Communications 31 (2008) 2937-2945 describe a proposal for a network in which a phased array antenna with electric beam steering capability is used by relay stations to communicate with a base station. The use of a passive direction of arrival algorithm is suggested for the beam steering towards the base station with the relay station scanning a range of angles, measuring received power of signals transmitted by the base station. An omnidirectional antenna is used by the relay station for communication with a mobile station.

US 2019/0265348 A1 describes a radar assisted tracking of mobile devices in which pulse signals are transmitted to determine positions of UEs within a predetermined area.

WO 2016/115545 A2 describes a method for beam forming, where a channel estimation between the base station and a plurality of UEs is used to perform the beamforming. This method requires feedback from the devices in order to estimate the channel and to enable and maintain the beams.

The present invention provides a method of operating a radio communications system first communication device, the method comprising identifying a position of an object which may comprise at least one second communication device by processing electromagnetic radiation emanating passively from the object; steering at least one of a receive beam and a transmit beam towards the object; and determining whether the object comprises at least one second communication device attempting to establish a radio communication with the first communication device.

In one aspect the invention uses a passive radar system co-located with a first communication device (e.g. eNB) to obtain and track the location of at least one or a group of second communication devices (e.g. UEs) and to steer a directed transmit and reception beam towards the at least one or a group of second communication devices.

This beam is intended for communication between the first and second communication device(s), and enables communication in both directions, i.e. from the first to the second communication device(s) and in the opposite direction. In case of communication between a base station and a mobile device, a connection may be set-up using a downlink transmit (Tx) beam and uplink reception (Rx) beam (from base station point of view). A connection may also be set-up using a downlink Rx beam and uplink Tx beam (from mobile device point of view). In case of communication between two mobile devices (e.g., in scope of direct UE-to-UE communication) a connection may be set-up using a sidelink Tx beam and a sidelink Rx beam (on either side). In case of communication between two base stations, a connection may be set-up using a backhaul Tx beam and a backhaul Rx beam (on either side).

Typically, a passive radar uses radio signals to detect objects. In the scope of this invention passive radar receivers comprise also receivers of other electromagnetic waves like visible and invisible light, microwaves, X-Ray and so on. Light detecting devices (e.g. optical cameras) and heat detecting devices (e.g., devices capable of receiving electromagnetic radiation in the infrared (IR) portion of the spectrum) are explicitly included in the list of passive radar receivers in the present invention.

The passive radar functionality may be equipped with a receiver arranged to receive electro-magnetic waves, a processor for processing received signals to identify the position and relevance of surrounding objects based on the received electro-magnetic waves, and data storage for storing properties of the detected objects. The processor may be arranged to compare previously stored properties with the newly detected (i.e. current) properties. The position of relevant objects may be communicated via a communication interface to a gNB in order to adjust radio beams towards these objects.

The passive radar regularly scans a surrounding area for objects. In case that a new object is detected, a downlink transmission beam is directed towards this object, and a corresponding uplink reception beam is established into the same direction. Further, the location/movement of this object is tracked, and the orientation of the pair of beams (i.e. downlink Tx beam and uplink Rx beam) are updated accordingly. Once a beam termination condition is met, the beam is terminated. This may be the case when the related object has entered the normal cell coverage (i.e. the area where coverage is provided without beam forming) or if there was no communication from any second communication device via this beam for a certain amount of time. Other beam termination conditions are for example blocking of the (line-of-sight) link between the first and the (group of) second communication device(s) by objects, or the (group of) second communication device(s) moving into the coverage area of another cell that is better suited to serve the (group of) second communication device(s), e.g. according to the received signal strength.

The passive radar-based method for beam steering can enable communication between a first communication device and far away second communication device, that is outside the normal coverage area of the first communication device, without any cooperation for beam steering by the second device, i.e. a constant feedback from the second device is not required anymore. Therefore, the second device is not required to be aware of the beam steering.

In the following it is assumed, that the first communication device is a base station (gNB) and the second communication device is a mobile station (UE). This simplification is done for easier reading and not to be understood as limitation. The method is also applicable if the passive radar functionality is co-located to a UE, which is therefore enabled to find other UEs or eNBs and to steer a beam towards these devices, in particular for identifying a relay station which is in contact with a base station where t.

A (group of) UE(s) residing in coverage of a beam that has been generated according to the method will obtain full access to the mobile network, i.e. detection of the cell, performing random access and UL/DL communications. This is beneficial, as no additional means are required in the UEs. The users of the UEs will benefit from an enhanced coverage area and may therefore obtain access to mobile communication services, especially where no access was possible before.

In contrast to a beam steering method, where continuous beam switching or beam hopping into alternating directions is used, this method enables the eNB to provide steady coverage to idle mode UEs, i.e. devices that are currently unable to send feedback, as the beam could be steered persistently to UE’s location.

The operator of the mobile network will benefit from additional and more satisfied users. In some deployment scenarios the density of base stations can be reduced (i.e. the inter-site distance (ISD) which influences both capital expenditure, CAPEX, and operating expenditure, OPEX, of the network directly can be larger than in legacy deployments thereby reducing costs for the mobile network operator).

In detail, the following are particular aspects of the present invention:
1 A first communication device is enabled to determine a location of potential second communication devices by means of a system that detects and tracks objects by processing reflections and/or emissions of various types (e.g. radio signals, heat waves, light or any other kind of electro-magnetic waves) from non-cooperative sources in the environment.
2 The first communication device is enabled to use the derived location information to steer a Tx beam and an RX beam towards the location (determined in step 1 above) in order to provide network access for the second communication devices or a communication link between the first and the second communication device(s).
3 The first communication device is enabled to establish the pair of beams according to one or more of the following rules:
   the object is newly detected in the surveilled area
   the object is outside the conventional coverage area
   the object most likely bear UEs
4 For these operations a comparison with data collected in the past for a particular orientation may be beneficial. A data base or storage means may therefore be provided for the first communication device.
5 The first communication device is enabled to disable the beam according to one or more of the following rules:
   no second communication device within the beam has used it for communication within a configurable time period.
   the object is inside the conventional coverage area
   beam blocking by obstacles
   a (group of) second communication device(s) moving into the coverage area of another cell that is (known to be) better suited to serve this (group of) second communication device(s).

Preferred embodiments of the invention will now be described, by way of example only, with reference to the accompanying drawings in which:

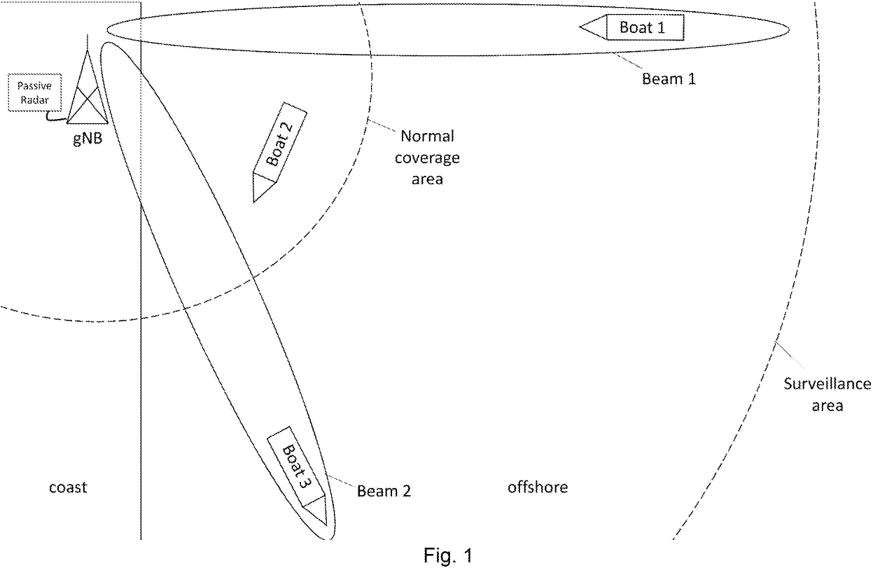

FIG. 1 shows an implementation of the invention in a coastal scenario;

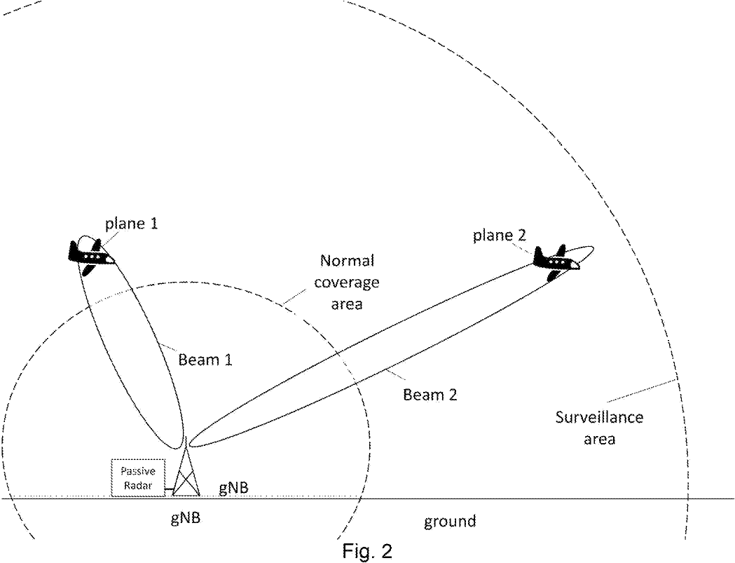

FIG. 2 shows an implementation of the invention in an airborne environment;

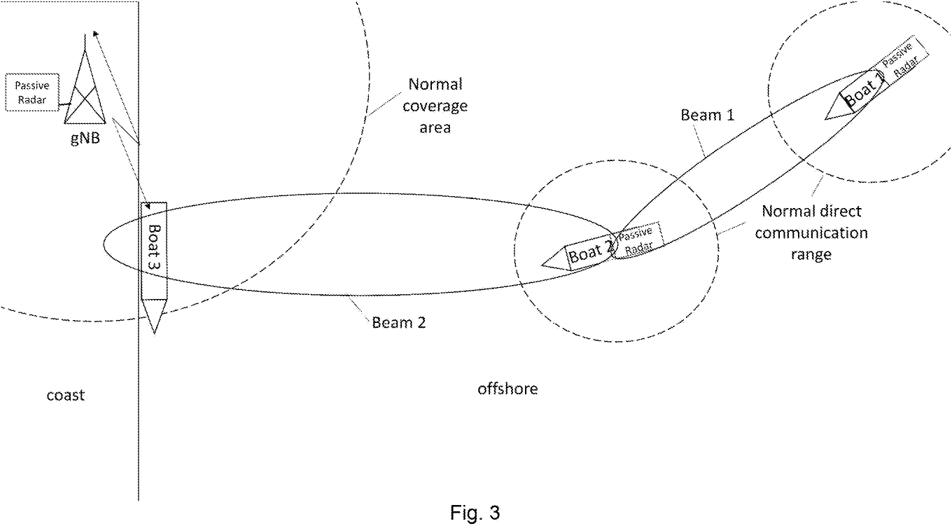

FIG. 3 shows an implementation of the invention in a concatenated manner;

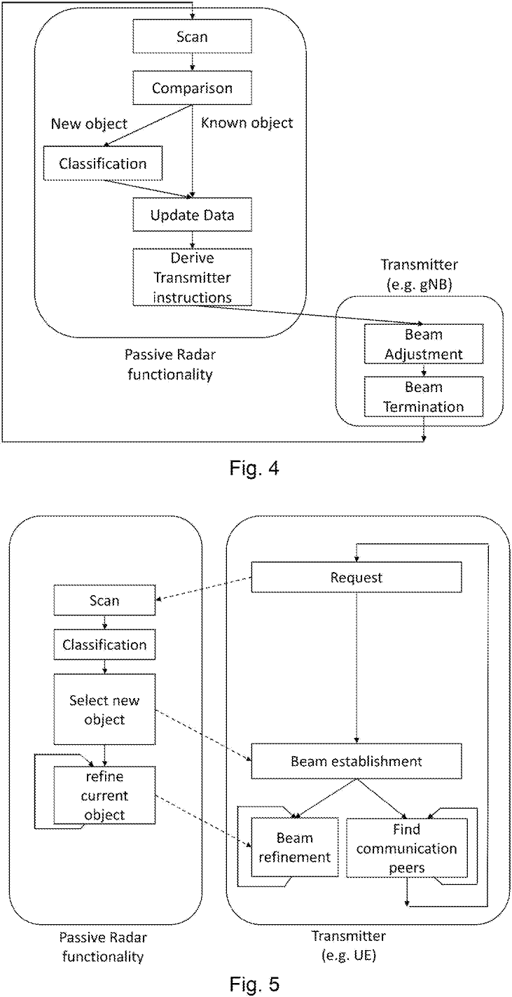

FIG. 4 is a flow chart showing steps for implementing the method of the invention; and

FIG. 5 is a further flow chart showing a second implementation of the invention.

Referring to FIG. 1 there is shown an exemplary scenario for the implementation of the invention. A passive radar functionality is deployed in, next to or coupled with a base station 10, which may be a gNB in case of a wireless communication system operating according to 3GPP’s 5G radio access technology, serving a coastal region. A similar situation is shown in FIG. 2 for serving aerial vehicles in a second example. The surveillance area for the passive radar functionality is configured in such a way that objects (e.g. boats/ships/ferries in FIG. 1, or aerial vehicles in FIG. 2) can be detected at least up to the maximum transmission and reception range of the beams.

Once the passive radar detects a new relevant object (e.g. a vessel or a plane), the gNB will consider steering a beam towards this object. Relevant objects are objects, that are considered by the passive radar functionality to bear UEs. In this case the base station is informed by the passive radar functionality at least about the direction and in another embodiment additionally about the distance of the detected vessels (or planes), so that the base station can adjust its coverage area over water (or in the air) accordingly by directing a downlink Tx beam and/or an uplink Rx beam towards the indicated direction (at least for a configurable amount of time). If no communications take place over the respective (pair of) beam(s) during said period of time, the base station can choose to remove (or, redirect) this (pair of) beam(s). Communication is than provided in the regular coverage area and in the remaining beams (if any). If the passive radar functionality does not detect any relevant objects within the surveillance area, then there is no need for the base station to adjust its regular coverage by directing beams towards the surveillance area.

In a further scenario shown in FIG. 3, the passive radar functionality is deployed in (or next to and coupled with) a mobile communication device (such as a UE in case of a wireless communication system operating according to 3GPP’s 4G or 5G radio access technology). This deployment enables the UE to communicate with other UEs or a base station, which is beyond the normal communication range of the UE. Such UE may be mounted for example on a container ship or boat (cf. Boat 1, Boat 2 and Boat 3 in FIG. 3). Said UE may establish a beam towards an object detected by passive radar technology thereby enabling communication with other UEs (or gNBs) deployed on this object. Further, such other UEs are enabled to relay the communication received from said UE. Therefore, a communication link can be enabled between a gNB, which offers a network connection, and a UE via multiple other UEs using multiple beams provided by several relaying UEs in series (In FIG. 3, Boat 1 has enabled one (pair of) beam(s), here collectively referred to as “Beam 1”, by using its own passive radar functionality towards Boat 2. Boat 2 has enabled yet another (pair of) beam(s) here collectively referred to as “Beam 2”, by using its own passive radar functionality towards Boat 3. Boat 3 is served by the gNB via the normal coverage area. In this example, (the UEs deployed on) Boat 3 and Boat 2 relay the communication link between (the UE deployed on) Boat 1 and the gNB, and (the UE deployed on) Boat 3 relays the communication between (the UE deployed on) Boat 2 and the gNB, and so on. In this scenario the network may not be aware of the beam forming techniques used by the various UEs involved. Therefore, no feedback from the gNB and no special interaction is required from the gNB.

The same principle is applicable for airborne vehicles, e.g. for drones or airplanes which establish beams between each other for relaying the communication.

FIG. 4 is a flow chart showing how a first embodiment of the invention may be implemented.

FIG. 4 shows two sub-charts, one on the left relating to passive radar functionality and one on the right relating to cellular transmitter activity.

The flow charts start with a precondition, step 0, that the passive radar functionality is running and has stored two lists: a first list containing objects identified as relevant and a second list containing objects identified as irrelevant. In this example, it has stored in these lists for each detected object an object identifier, object type, the angle and distance of the object in relation to the position of the passive radar receiver and the speed and direction of movement. The data were derived previously as described in the next steps below. An example of the list of relevant objects is shown in table 1. In a system designed for detecting moving objects, objects which remain stationary for a statistically significant time could be classed as irrelevant, for example.

TABLE 1

| | | | | | | |
|---|---|---|---|---|---|---|
| Object-ID | Object type | Distance | Horizontal angle | Vertical angle | Speed | Direction of movement |
| 1 | Large ship | 58 km | 12° | 0° | 25 km/h | East |
| 2 | Large airplane | 89 km | 58° | 33° | 800 km/h | North-East |
| ... | | | | | | |

In a scan step, step 1, the passive radar functionality performs a further scan of the electro-magnetic waves. The result of this scan are detected objects with their location in relation to the location of the passive radar functionality.

In a comparison step, step 2, the objects of the new scan result are compared with the stored data in the list of relevant and the list of irrelevant objects. This is done to distinguish new objects from already stored objects. In case an object has appeared, that is not already stored, this object is considered as “new object” and step 4 is performed or otherwise as “known object” and step 5 is performed.

In a classification step, step 3, detected new objects are classified according to their likelihood to bear UEs. This is more likely for bigger objects like cruise ships and airliners. A new object is classified as “relevant object”, if it may potentially bear UEs, or otherwise as “irrelevant object”. For this classification additional parameters of the object can be considered, e.g. the size, height above sea level, shape (if allowed by the granularity of the incoming radar signal), moving direction and speed of the object. If any or multiple of the additional parameters are not fulfilling a pre-determined criterion, the object is classified as “irrelevant object” otherwise as “relevant object”. The determination of the relevance may depend on the use case, e.g. whether the beams are intended to be steered towards airplanes or ships or a group of pedestrians. The relevance for ships is for example higher, if the object is at sea level and larger and slower compared to a reference value. In this case it is considered as a cruise ship or possibly a container ship, that will most likely bear UEs, and is distinguishable from smaller and/or faster ships, that bear only a few UEs. Further, the relevance is higher, if the object is approaching the gNB, as this will increase the duration of potential communications. Other criteria may be defined, that will match to a passenger aircraft, e.g. the altitude is larger than 5.000 m above sea level and the speed is above 500 km/h. Of course, both sets of criteria can be used by the same passive radar functionality in order to provide radio beams to ships and airplanes simultaneously, and further sets of criteria can be used for other kinds of UE-bearing objects (e.g. trains, cars) or even people carrying UEs with them. The derived relevance value is compared to a pre-configured reference value and the object is assigned either to the list of relevant objects, if it is above the reverence value, or otherwise to the list of irrelevant objects. A new entry is created in the selected list for the new object and a new object ID is assigned to the new object and stored in the list.

In an updating step, step 4, the stored data of objects are updated according to the outcome of the latest scan. I.e. the location and movement parameters will be updated, if they have changed. The speed of movement is for example calculated from the last and the current location, or the scan itself delivers the object speed. The updates will be made in both lists, i.e. the list of relevant objects and the list of irrelevant objects.

In step 5, transmitter instructions are derived. After new scan results were included in the object data lists, the passive radar functionality creates a message for the gNB to be used for beam adjustment:
The location and movement properties (e.g. direction, distance, movement direction, movement speed) of newly detected “relevant objects” are indicated to the gNB including the object ID; and
The remaining objects from the list of “relevant objects” (i.e. the known objects thereof) are evaluated, whether there have been significant changes compared to the latest reported values or the values stored from the last scan. Only data with a significant change (e.g. the offset is above a configurable threshold) will be indicated to the gNB.

The passive radar functionality will then indicate the selected parameters to the gNB.

In a beam adjustment step, step 6, the gNB updates already established beams and establishes new beams according to the latest received instructions, i.e. it selects the antenna weights and delays of each antenna element of the adaptive antenna array so that the resulting transmitted signals are directed in the indicated direction which leads to an increased signal level in this direction while the signal level in other directions is mainly reduced (for the downlink Tx beam from gNB point of view). This directional signal attenuation is also valid for the reception of signals by this antenna array (i.e. for the uplink Rx beam from gNB point of view). For the newly established (pair of) beams, the object ID, that causes this beam establishment, is mapped to this beam. For further received changes of any objects, the gNB will consider them for the related beam. Further, a timer is started after a new beam is established. The gNB further checks, whether any of the known objects which are provided with a beam, has entered the area of normal coverage. The related beams will be terminated, and the communication will be taken over by the cell which provides the normal coverage. The gNB even further checks, whether any of the known relevant objects that are provided by the normal coverage area, is likely to leave the normal coverage area. In this case the gNB will establish a new beam towards the related objects, which takes over the communication.

Step 7 is a beam termination step: The gNB regularly checks whether any communication has taken place via the established beams. Once a timer started in step 7 expires and no communication has taken place, the beam may be terminated.

The procedure then continues with step 2.

A further flow chart is shown in FIG. 5 relating to a second embodiment. In the second embodiment, a passive radar functionality is equipped with a receiver to receive electro-magnetic waves, a processor, to identify the position and relevance of surrounding objects based on the received electro-magnetic waves, storage capacity, to store properties of the detected objects, a comparator, to compare previously stored properties with the newly detected (i.e. current) properties, and means for receiving object location requests and for indicating positions of relevant objects to a UE in order to adjust radio beams towards these objects.

In step 11, the UE wants to communicate and has failed to find any communication peer (without any help of the passive radar functionality). Therefore, it sends a request for locations of relevant objects to the passive radar functionality.

After reception of the request, in step 12 the passive radar functionality performs a scan of the surveillance area. It scans for electro-magnetic waves (This is an example, i.e. to scan for other kind of signals (visual light, thermal radiation, ...) instead or in addition to thermal radiation is also suitable). The result are objects with their location in relation to the location of the passive radar functionality.

In step 13, detected new objects are classified according to their likelihood to bear UEs. This is done similar to the classification described above. The detected objects are stored with the related location properties in the respective list according to their classification. In addition, the calculated “relevance value” is stored, so that it can be used to select the most relevant object.

After new scan results were included in the object data lists, the passive radar functionality selects in step 14 the most valuable object from the list of relevant objects. In this example, it selects the nearest object that is of container-ship size. Then, it may perform an additional scan of the area about the selected object to derive further properties of this object, e.g. the speed and movement direction. After that, it creates a message that includes the location properties of the selected object and transmits this message to the UE to be used for beam adjustment. The selected object is moved to the list of “already used relevant objects”, so that it is not selected for subsequent requests.

In step 15 the UE establishes a beam in the indicated direction.

As shown in step 16, the passive radar functionality regularly performs additional scans of the area about the selected object to derive the current location properties of this object. In case the properties have changed compared to the latest scan, it will transmit an update message with the new properties to the UE.

The UE tries in step 17 to find a communication peer that is able and willing to relay communication towards a communication network. Therefore, it transmits a request message within the established beam, preferably as a broadcast message. In case that a peer will accept the request, it transmits an accept message to the UE. Then, the UE establishes a connection towards this device. In case that more than one UE will accept the request, the UE will select the best suited peer, e.g. by considering the signal quality, the number of hops (i.e. the number of relaying devices in the path) towards the communication network, the costs or other parameters which will affect the communication service.

Simultaneously to step 17, the UE will in step 18 continuously refine the beam adjustment according to the received instructions from the passive radar functionality.

In case that no communication peer within the currently established beam is suitable for the UE, it will at step 19 again request the passive radar functionality for another suitable object. The procedure is re-entering step 12, until a connection is successfully established or until no more relevant objects are left.

1. A method of operating a radio communications system first communication device, the method comprising:
identifying a position of an object which may comprise at least one second communication device by processing electromagnetic radiation emanating passively from the object;
steering at least one of a receive beam and a transmit beam towards the object; and
determining whether the object comprises at least one second communication device attempting to establish a radio communication with the first communication device.

2. The method according to claim 1, wherein the electromagnetic radiation is one of radio signals, infrared radiation, and visible light.

3. The method according to claim 1, wherein the position of the object is determined using passive radar functionality.

4. The method according to claim 3, wherein the passive radar functionality is used to classify detected objects according to a likelihood that the detected objects are a potential second communication device.

5. The method according to any preceding claim, wherein changes in the position of the object are monitored and the first communication device periodically determines whether the object is a second communication device attempting to establish a radio communication with the first communication device.

6. The method according to any preceding claim, wherein the steered beam or steered beams are disabled in response to a predetermined condition.

7. The method according to claim 6, wherein the predetermined condition is one of no second communication device having been identified with a predetermined time period, the second communication device being within an area of coverage of another device communication mode, an interfering object being identified and the second communication device moving into a communication coverage area of a different communication device.

8. The method according to any preceding claim, wherein the second communication device is requested to act as a relay station.

9. A radio communication device comprising:
means for determining a location of an object which comprises at least one potential second communication device;
means for steering at least one of a receive beam direction and a transmit beam direction towards the location of the object; and
means for determining whether the object comprises at least one second communication device attempting to establish a radio communication with the radio communication device.

10. The radio communication device according to claim 9, wherein the radio communication device further comprises means for steering a transmit beam towards the object.

11. A passive radar system comprising a receiver of electromagnetic radiation, a processor for processing received electromagnetic radiation signals in order to determine a position of an object, a data storage for storing data relating to a determined object position, and a communication interface to a mobile communication system in order to provide the mobile communication system with information relating to the determine object position.

12. The method according to claim 2, wherein the position of the object is determined using passive radar functionality.
